(19) United States
(12) Patent Application Publication
(10) Pub. No.: US 2002/0198714 A1
(43) Pub. Date: Dec. 26, 2002

(54) Statistical spoken dialog system

(76) Inventor: Guojun Zhou, Portland, OR (US)

Correspondence Address: PILLSBURY WINTHROP, LLP, P.O. BOX 10500, MCLEAN, VA, 22102, US

(21) Appl. No.: 09/891,224

(22) Filed: Jun. 26, 2001

(51) Int. Cl. G10L 15/04; G10L 15/00

(52) U.S. Cl. 704/252

(57) ABSTRACT

An arrangement is provided for an automated statistical spoken dialogue system that interprets the semantic meaning of input speech data based on the literal meaning of the input speech data and one or more semantic models. A response is then generated according to the semantic meaning of the input speech data.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to human computer interaction. Other aspects of the present invention relate to spoken dialogue systems.

Automated spoken dialogue systems have many applications. For example, in weather information services, a user may ask a question about the weather of a particular city to a spoken dialogue system, which may activate a back end server to retrieve the requested weather information based on the understood meaning of the question, synthesize a voice response based on the retrieved weather information, and play back the response to the user. When a spoken dialogue system is used in a dictation environment, a user's request may correspond to the execution of an action performed on a specified object. For example, in a home entertainment center where appliances may be controlled via voice command, a spoken dialogue system may be deployed as a voice based interface to correctly understand a user's requests.

Dialogues in a natural language often exhibit ambiguities. Although many automated spoken dialogue systems deal with a constrained, instead of generic, language, ambiguities in understanding the semantic meaning of spoken words often still exist. Furthermore, the semantic meaning or the intent of a spoken sentence often can not be inferred even when the literal meaning of the sentence is understood. In language based systems, such ambiguities may cause degradation of the system performance. For instance, the intent (or the semantics) of the sentence “lower the volume” in a home entertainment environment may be ambiguous even though the literal meaning of the spoken words may be well understood. In this particular example, the ambiguity may be due to the fact that there are several appliances in the same household whose volume can be controlled but the sentence did not explicitly indicate exactly which appliance's volume is to be lowered.

Discourse history has been used to resolve ambiguities in languages. For example, to determine what “it” means in sentence “make it lower”, the closest noun in a sentence occurred right before “make it lower” (e.g., “put up the panda picture”) may be identified from a discourse history to determine the meaning of “it” (e.g., “it” means “the panda picture”). Although discourse history may help in some situations, it does not always work. For instance, discourse history does not help to disambiguate the intent of the sentence “lower the volume” if a user wants to lower the volume of the radio that is turned on earlier than a stereo system through voice commands.

In a voice-based environment, different semantic meanings of a spoken dialogue may be mapped to different actions. Misunderstanding the semantic meaning or the intent of a command often leads to system misbehavior that sacrifices system performance and causes user's frustration and dissatisfaction.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 is a high-level system architecture of embodiments of the present invention;

FIG. 2 illustrates an exemplary internal structure of a statistical spoken dialogue system and the environment in which it operates, according to the present invention;

FIG. 3 shows exemplary relationships between a literal meaning of a word sequence and a plurality of semantic meanings that may further associate with different environmental information;

FIG. 4 is an exemplary flowchart of a statistical spoken dialogue system, in which the semantic meaning of input speech data is interpreted based on semantic models derived from annotated training data, according to the present invention;

FIG. 5 illustrates an exemplary internal structure of a speech understanding mechanism;

FIG. 6 depicts the high-level functional block diagram of a dialogue semantic learning mechanism, according to the present invention;

FIG. 7 is an exemplary flowchart of a process, in which annotated dialogue training data is used to establish semantic models, according to the present invention;

FIG. 8 depicts the high-level functional block diagram of a statistical dialogue manager according to the present invention;

FIG. 9 is an exemplary flowchart of a process, in which a statistical dialogue manager interprets the semantic meaning of input speech data based on semantic models corresponding to the literal meaning of the input speech data and associated environmental status, according to the present invention; and

FIG. 10 depicts an exemplary internal structure of a responding mechanism.

### DETAILED DESCRIPTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

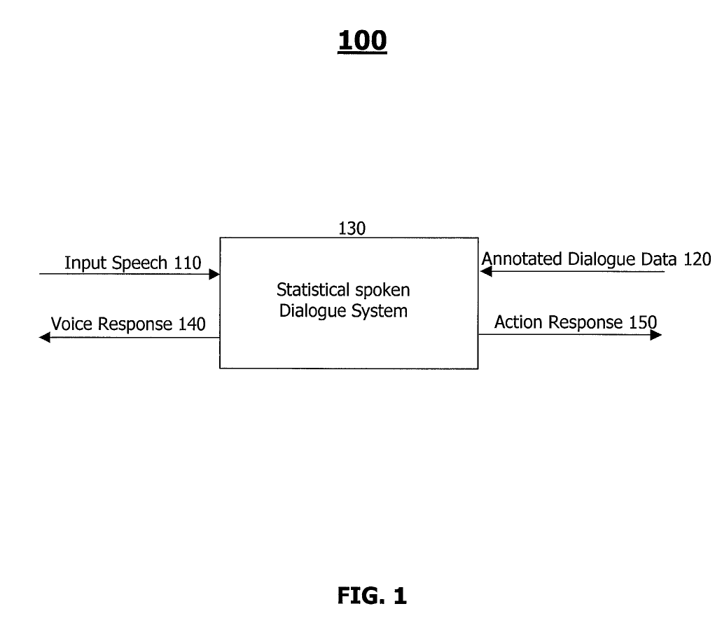

FIG. 1 depicts a statistical spoken dialogue system 130 with exemplary inputs and outputs according to the present invention. In FIG. 1, the statistical spoken dialogue system 130 takes input speech 110 and annotated dialogue data 120 as input and generates appropriate responses. The input speech 110 represents speech signals from a user, with whom the statistical spoken dialogue system 130 is conducting a voice-based dialogue.

In FIG. 1, the input speech 110 may correspond to an analog waveform recorded directly from a user. The input speech 110 may also correspond to a digital waveform digitized from an analog waveform according to, for example, certain sampling rate. In the former case, the statistical spoken dialogue system 130 may first digitize the input speech 110 before processing the input speech.

In an automated spoken dialogue scenario, a user may converse with an automated spoken dialogue system, issuing requests and receiving automatically generated responses. Such requests may include asking for certain information or demanding an action to be performed on a device. For example, with a voice portal, a user may state a request for weather information via a phone and receive the requested weather information from the voice portal through the same phone. In a home entertainment center, a user may request a spoken dialogue system, serving as the voice based interface of an automated home appliance control center, to turn off the television in the family room.

When a user's voice request is understood, an automated spoken dialogue system may generate a response to the request. Such a response may simply acknowledge the request or may activate the action that is being requested. In FIG. 1, the statistical spoken dialogue system 130 may generate a voice response 140 or an action response 150, both based on the understanding of the intent or the semantic meaning of the input speech 110. For example, if a user requests, via input speech 110, the statistical spoken dialogue system 130 to activate appropriate control mechanism to turn on a stereo system, the statistical spoken dialogue system 130 may first interpret the semantic meaning or the intent of the request. For example, a request to “turn on the stereo system” may be interpreted to mean (or to intend to) “turn on the stereo system in the family room”. According to the interpreted intent or the semantic meaning of the request, the statistical spoken dialogue system 130 may generate both a voice response 140, which may say “the stereo system in the family room is now turned on”, and an action response 150, which may activate a home appliance control mechanism to turn on the stereo system in the family room.

To properly understand the semantic meaning of input speech 110, the statistical spoken dialogue system 130 utilizes annotated dialogue data 120 to learn and to model the relationship between the literal meaning of input speech and potentially more than one semantic meaning of input speech. The literal meaning of a request may correspond to multiple semantic meanings or different intentions. For example, when a user requests “turn on the stereo system”, its literal meaning may be well defined. But its semantic meaning may be ambiguous. For instance, in a home appliance control center, there may be three stereo systems (e.g., in the living room, in the family room, and in the library) in the household. In this particular setting, either the exact semantic meaning of the request “turn on the stereo system” may need to be clarified before taking an action to execute the request or an educated guess about the intent of the request may be made based on some knowledge learned based on past dialogues experience.

The annotated dialogue data 120 may record the relationships between literal meanings of requests and their corresponding semantic meanings collected at different time instances. Such annotated data may be generated during prior dialogues. In each of such dialogues, the literal meaning of a user's request may be confirmed to link to a specific semantic meaning. Requests made at different times may be confirmed to link to different semantic meanings. The overall collection of the annotated dialogue data 120 may provide useful information about the statistical properties of the relationships between the literal meanings and the semantic meanings of requests. For example, across an entire set of annotated dialogue data 120, 70% of all the requests “turn on the stereo system” may correspond to the semantic meaning “turn on the stereo system in the family room”, 20% may correspond to the semantic meaning “turn on the stereo system in the library”, and 10% may correspond to the semantic meaning “turn on the stereo system in the living room”.

In FIG. 1, the statistical spoken dialog system 130 interprets the semantic meaning of the input speech 110 based on the knowledge learned from the annotated dialogue data 120. Statistical properties of the annotated dialogue data 120 may be characterized and used to understand or infer the semantic meaning of future input speech.

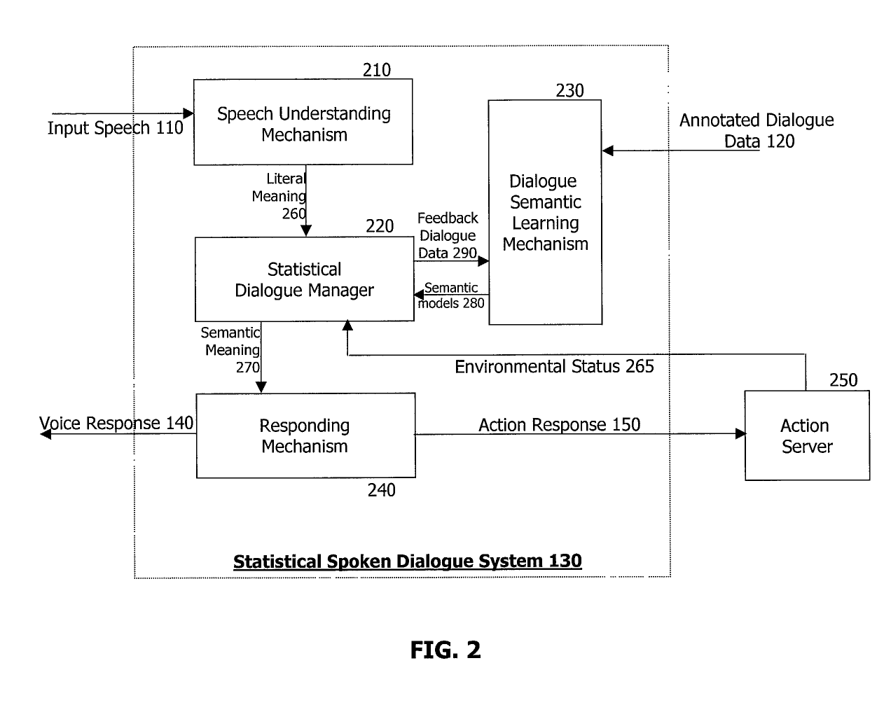

FIG. 2 illustrates an exemplary internal structure of the statistical spoken dialogue system 130 and the environment in which it operates, according to the present invention. In FIG. 2, the statistical spoken dialogue system 130 comprises a speech understanding mechanism 210, a statistical dialogue manager 220, a dialogue semantic learning mechanism 230, and a responding mechanism 240.

The speech understanding mechanism 210 takes the input speech 110 as input and generates a literal meaning 260 corresponding to the input speech 110 based on speech understanding techniques. To determine the literal meaning of the input speech 110, the speech understanding mechanism may recognize spoken words from the input speech 110 to generate a word sequence. Such recognition may be performed based on the phonemes recognized from the waveform signals of the input speech 110. The speech understanding mechanism 210 may then further analyze the word sequence to understand its literal meaning.

A word sequence represents a list of individual words arranged in certain order. Recognizing a word sequence usually does not mean that the meaning of the word sequence is understood. For example, word sequence “turn on the stereo system” is simply a pile of words “turn”, “on”, “the”, “stereo”, and “system”. The literal meaning of a word sequence represents an understanding of the word sequence with respect to a language (which may be modeled using both a vocabulary and a grammar). For instance, the literal meaning of word sequence “turn on the stereo system” indicates to perform a “turn on” action (corresponding to the verb part of a sentence) on a device called “stereo system” (corresponding to the object part of a sentence).

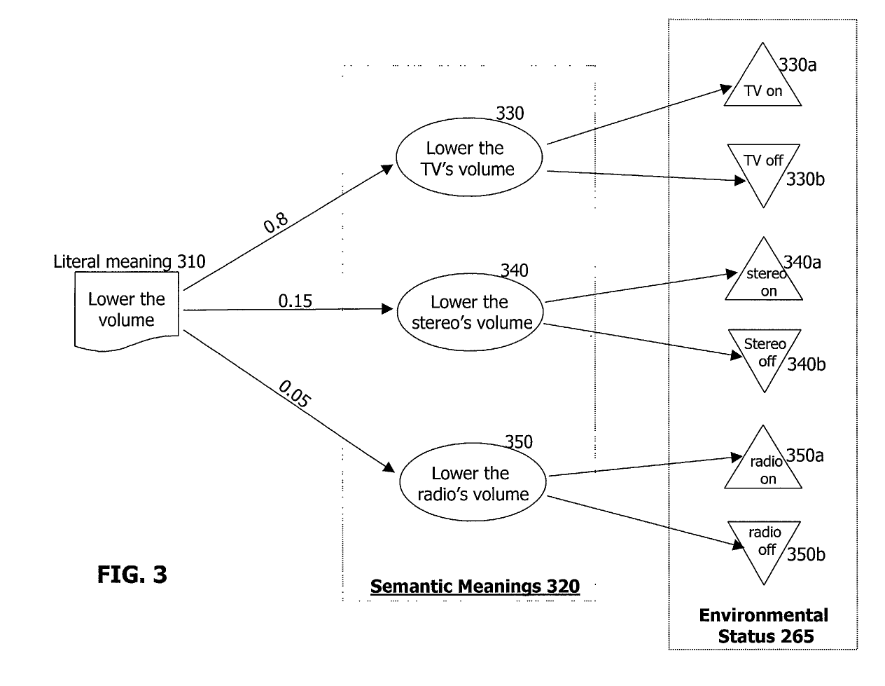

As discussed earlier, understanding the literal meaning of a user's spoken request does not necessarily mean that the semantic meaning of the request is understood. Such ambiguity may occur in different application environments. For example, in some house, there may be only one stereo system and, in this case, the literal meaning of request “turn on the stereo system” corresponds directly to the only possible semantic meaning. When there are multiple stereo systems, the ambiguity arises. FIG. 3 illustrates such an example.

FIG. 3 describes exemplary relationships between a literal meaning of a request and a plurality of semantic meanings that may further associate with different environmental status. In FIG. 3, a literal meaning 310 of request “lower the volume” corresponds to different semantic meanings (320): “lower the TV's volume” (330), “lower the stereo's volume” (340), and “lower the radio's volume” (350). The three different semantic meanings relating to the literal meaning 310 may correspond to three disjoint actions. To execute the request “lower the volume”, a most likely semantic meaning of the request may be properly identified.

In FIG. 2, the dialogue semantic learning mechanism 230 takes the annotated dialogues data 120 as input to learn the relationships between the literal meanings of requests and their corresponding semantic meanings. For example, the dialogue semantic learning mechanism 230 may statistically characterize the relationships and then establish appropriate models to represent such relationships. The characterization of the relationships between the literal meanings and semantic meanings yield semantic models 280, which may then be used, as shown in FIG. 2, by the statistical dialogues manger 220 to determine the semantic meaning of input speech 110 during an active dialogue session.

An exemplary statistical model for the relationship between request “lower the volume” and its semantic meanings is shown in FIG. 3, wherein the correspondence between the literal meaning of request “lower the volume” and each of its possible semantic meanings 330, 340, 350 is characterized using a probability. For instance, the probability that the request “lower the volume” means “lower the TV's volume” is 0.8. Similarly, the probabilities with respect to semantic meanings “lower the stereo's volume” and “lower the radio's volume” are 0.15 and 0.05, respectively. The dialogues semantic learning mechanism 230 may derive such probabilities from the annotated dialogue data 120 and use them to construct appropriate semantic models 280, such as the one illustrated in FIG. 3.

The example shown in FIG. 3 further illustrates that determining the semantic meaning of a request sometimes may rely on information other than the semantic models 280. For example, the semantic meaning of a request may depend on other factors such as environmental status 265. In FIG. 3, each of the semantic meanings 330, 340, 350 is associated with a different device (TV, stereo, and radio) and, at any time, each of the associated devices may have a particular state such as “on” and “off”. Collectively, current states of different devices form current environmental status 265 that may affect the interpretation of the semantic meaning of a request. For instance, if a television is currently turned off (current environmental status 330a of the television), request “lower the volume” is unlikely corresponding to the semantic meaning of “lower the TV's volume” 330.

In FIG. 2, the statistical dialogue manager 220 determines the semantic meaning 270 that corresponds to the literal meaning 260 based on both the semantic models 280 as well as the environmental status 265. Using the example illustrated in FIG. 3, if the semantic model for literal meaning 310 (“lower the volume”) indicates that the probabilities that literal meaning 310 corresponds to the semantic meanings 330 (“lower the TV's volume”), 340 (“lower the stereo's volume”), and 350 (“lower the radio's volume”) are 0.8, 0.15, and 0.05, respectively, and if the TV is currently turned off and the stereo as well as the radio are turned on, the statistical dialogue manager 220 may determine the semantic meaning of “lower the volume” to be “lower the stereo's volume” instead of “lower the TV's volume”.

The responding mechanism 240 in FIG. 2 generates an appropriate response according to the semantic meaning 270. A response generated by the responding mechanism 240 may correspond to a voice response 140 or an action response 150. The action response 150 may correspond to sending an activation signal to an action server 250 that may be designed to control different appliances. For instance, if the semantic meaning 340, “lower the stereo's volume”, is selected as the interpretation of the request “lower the volume” (310), the responding mechanism 240 may send an activation request, with possibly necessary control parameters, to the action server 250 to lower the volume of the stereo. Necessary control parameters may include a designated device name (e.g., “stereo”), a designated function (e.g., “volume”), and a designated action to be performed (e.g., “lower”).

The voice response 140 generated by the responding mechanism 240 corresponds to a spoken voice, which may be either an acknowledgement or a confirmation. For example, the voice response 140 may simply say “the requested action has been performed” if the semantic meaning 270 is considered unambiguous. In this case, the corresponding action response 150 may be simultaneously performed.

The statistical dialogue manager 220 may also result in more than one semantic meaning 270. This may occur when multiple semantic meanings have similar probabilities and similar environmental status. For example, if the probabilities between literal meaning 310 and semantic meaning 330 as well as semantic meaning 340 are equal (e.g., both 0.45) and the corresponding environmental states of their underlying devices are also the same (e.g., both “on”), the statistical dialogue manager 220 may decide that confirmation or clarification is needed. In this case, appropriate voice response 140 may be generated to confirm, with the user, one of the multiple semantic meanings and the corresponding action response may be delayed until the confirmation is done.

During confirmation, the responding mechanism 240 may generate a confirmation question such as “which device do you like to lower the volume?”. Further response from the user (answering lower the volume of which device) to such a confirmation question may then be used (in the statistical spoken dialogue system 130) as the input speech 110 in the next round of a dialogue session. Such confirmation may take several loops in the dialogue session before one of the semantic meanings is selected. Once the statistical dialogue manager 220 confirms one of the semantic meanings, the responding mechanism 240 may then generate an appropriate action response with respect to the confirmed semantic meaning.

A semantic meaning can be confirmed through either an explicit confirmation process (described above) or an implicit process. In an implicit process, a semantic meaning may be confirmed if the user (who issues the request) does not object the response, both the voice response 140 and the action response 150, generated based on an interpreted semantic meaning. Each confirmed semantic meaning of a request establishes an instance of the relation to the corresponding literal meaning of the request. Such an instance may be automatically annotated, by the statistical dialogue manager 220, to generate feedback dialogue data 290, which may then be sent to the dialogue semantic learning mechanism, as part of the annotated dialogue data 120, to improve the semantic models 280.

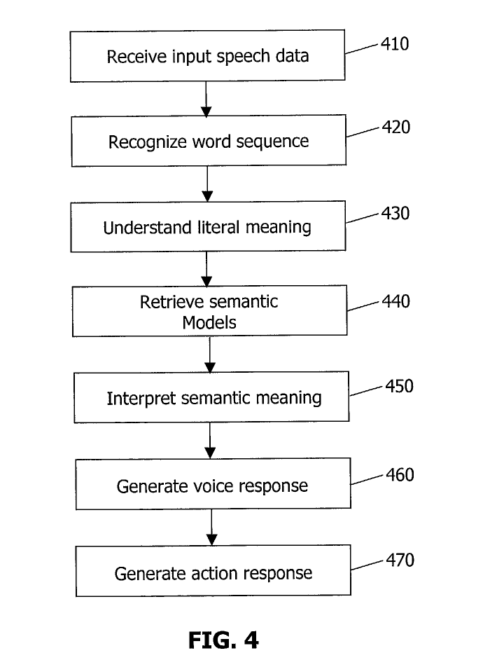

FIG. 4 is an exemplary flowchart of the statistical spoken dialogue system 130 according to the present invention. In FIG. 4, the semantic meaning of input speech data is determined based on semantic models, derived from annotated dialog training data, according to the present invention. Input speech data 110 is received at act 410. Based on the input speech data 110, the speech understanding mechanism 210 first recognizes, at act 420, spoken words from the input speech data to generate a word sequence. The literal meaning of the word sequence is then determined at act 430.

Based on the literal meaning of the input speech data, relevant semantic models 280 are retrieved, at act 440, from the dialog semantic learning mechanism 230. Using the semantic models 280 and the environmental status 265, the statistical dialogue manager 220 interprets, at act 450, the semantic meaning of the input speech data. The interpretation performed at act 450 may include more than one round of confirmation with the user. The confirmed semantic meaning 270 is then used, by the responding mechanism 240, to generate, at acts 460 and 470, a voice response 140 and an action response 150.

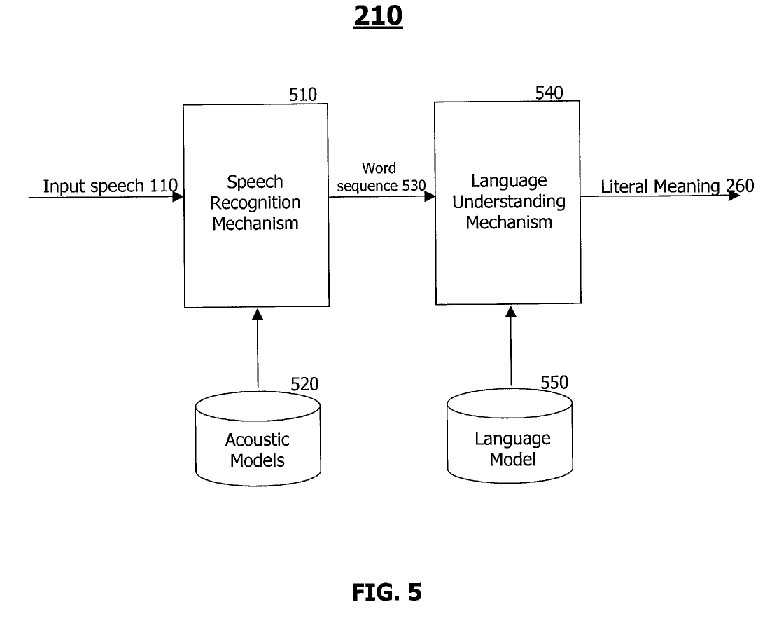

FIG. 5 illustrates an exemplary internal structure of the speech understanding mechanism 210. In FIG. 5, the speech understanding mechanism 210 includes a speech recognition mechanism 510 and a language understanding mechanism 540. The speech recognition mechanism 510 takes the input speech data 110 as input and recognizes a word sequence 530 from the input speech data based on acoustic models 520. The language understanding mechanism 540 takes the word sequence 530 as its input and determines the literal meaning of the input speech 110 based on a language model 550.

The acoustic models 520 may be phoneme based, in which each word model is described according to one or more phonemes. The acoustic models 520 are used to identify words from acoustic signals. A language model specifies allowed sequences of words that are consistent with the underlying language. A language model may be constructed using finite state machines. The language model 550 in FIG. 5 may be a generic language model or a constrained language model that may describe a smaller set of allowed sequences of words. For instance, a constrained language model used in an automated home appliance control environment may specify only 10 allowed sequences of words (e.g., corresponding to 10 commands).

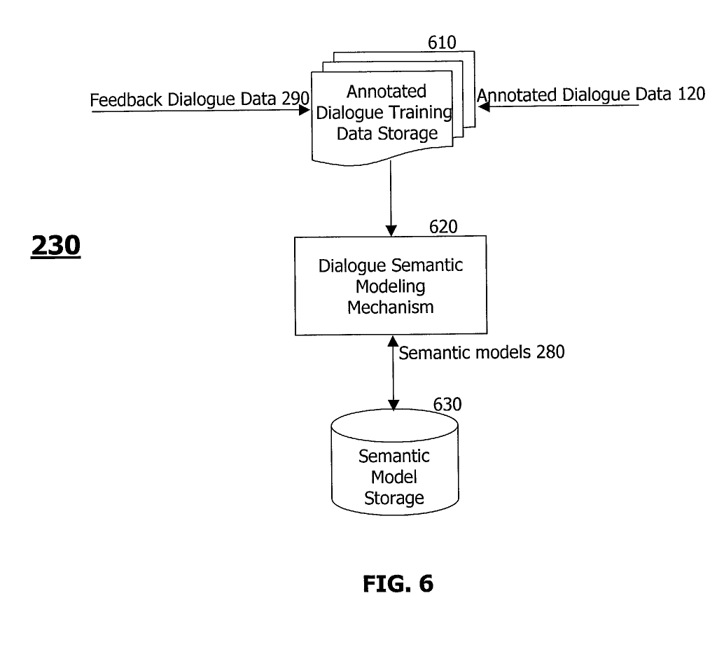

FIG. 6 depicts the high-level functional block diagram of the dialogue semantic learning mechanism 230 that is functional and consistent with the present invention. In FIG. 6, the dialogue semantic learning mechanism 230 includes an annotated dialogue training data storage 610, a dialogue semantic modeling mechanism 620, and a semantic model storage 630. The dialogue semantic learning mechanism 230 may receive annotated dialogue training data from different sources. One exemplary source is the annotated dialogue training data 120 and the other is the feedback dialogue data 290. The former refers to the dialogue data that is annotated off-line and the latter refers to the dialogue data that is annotated on line.

Off line annotated dialogue data may be obtained from different sources. For example, the statistical spoken dialogue system 100 may output all of its dialogue data to a file during dialogue sessions. Such dialogue data may be later retrieved off-line by an annotation application program that allows the recorded dialogue data to be annotated, either manually or automatically. The annotated dialogue data 120 may also be collected in different ways. It may be collected with respect to individual users. Based on such individualized annotated dialogue data, personal speech habits may be observed and may be modeled. Personalized semantic modeling may become necessary in some applications in which personalized profiles are used to optimize performance.

The annotated dialogue data 120 may also be collected across a general population. In this case, the annotated dialogue data 120 may be used to characterize the generic speech habits of the sampled population. The semantic models trained based on the annotated dialogue data 120 collected from a general population may work for a wide range of speakers with a, may be, relatively lower precision. On the other hand, the semantic models trained based on the annotated dialogue data collected on an individual basis may work well, with relatively high precision, for individuals yet it may sacrifice the generality of the models. A dialogue system may also have both personalized and general semantic models. Depending on the specific situation in an application, either personalized or general models may be deployed.

The feedback dialogue data 290 may be generated during active dialogue sessions according to the present invention. As mentioned earlier, whenever a particular semantic meaning corresponding to a give literal meaning of the input speech data is confirmed, the correspondence between the literal meaning and the semantic meaning can be explicitly annotated so. Each piece of such annotated dialogue data represents one instance of the correspondence between a particular literal meaning and a particular semantic meaning. Collectively, annotated instances during active dialogue sessions form feedback dialogue data 290 that may provide a useful statistical basis for the dialogue semantic learning mechanism 230 to learn new models or to adapt existing semantic models. Similar to the annotated dialogue data 120, the feedback dialogue data 290 may also be collected with respect to either individuals or a general population.

The dialogue semantic modeling mechanism 620 utilizes the annotated dialogue data to model the relationships between each literal meaning and its corresponding semantic meanings. The modeling may capture different aspects of the relationships. For example, it may describe how many semantic meanings that each literal meaning is related to and the statistical properties of the relations to different semantic meanings. The example given in FIG. 3 illustrates that literal meaning 310 is related to three different semantic meanings, each of which is characterized based on a probability. The probabilities (0.8, 0.15, and 0.05) may be derived initially from a collection of annotated dialogue training data 120. The dialogue semantic modeling mechanism 620 may continuously adapt these probabilities using the on-line feedback dialogue data 290.

In FIG. 6, semantic models may be stored in the semantic model storage 630. The stored semantic models 280 may be indexed so that they can be retrieved efficiently when needed. For example, semantic models may be indexed against literal meanings. In this case, whenever a particular literal meaning is determined (by the speech understanding mechanism 210 in FIG. 2), the semantic models corresponding to the literal meaning may be retrieved from the semantic model storage 630 using the indices related to the literal meaning.

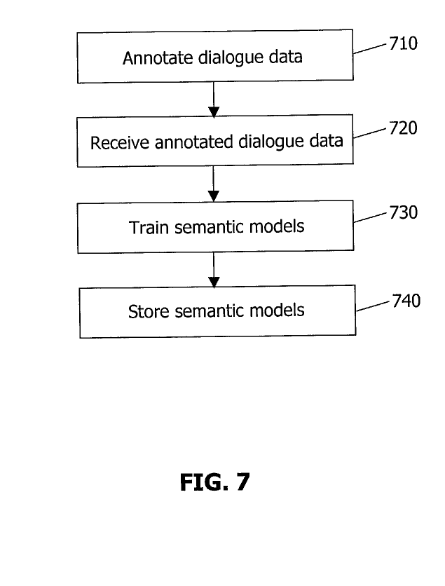

FIG. 7 is an exemplary flowchart of a process, in which annotated dialogue training data is used to establish semantic models, according to the present invention. In FIG. 7, dialogue data is first annotated at act 710. The annotation may be performed off-line or online and it may also be performed manually or automatically. Whenever annotated dialogue data is received at act 720, the dialogue semantic modeling mechanism 620 may be triggered to train corresponding semantic models at act 730. Depending on the content of the annotated data, the training may involve establishing new semantic models or it may involve updating or adapting relevant semantic models. In the latter case, the dialogue semantic modeling mechanism 620 may first retrieve relevant semantic models from the semantic model storage 630. The trained semantic models are then stored, at act 740, in the semantic model storage 630.

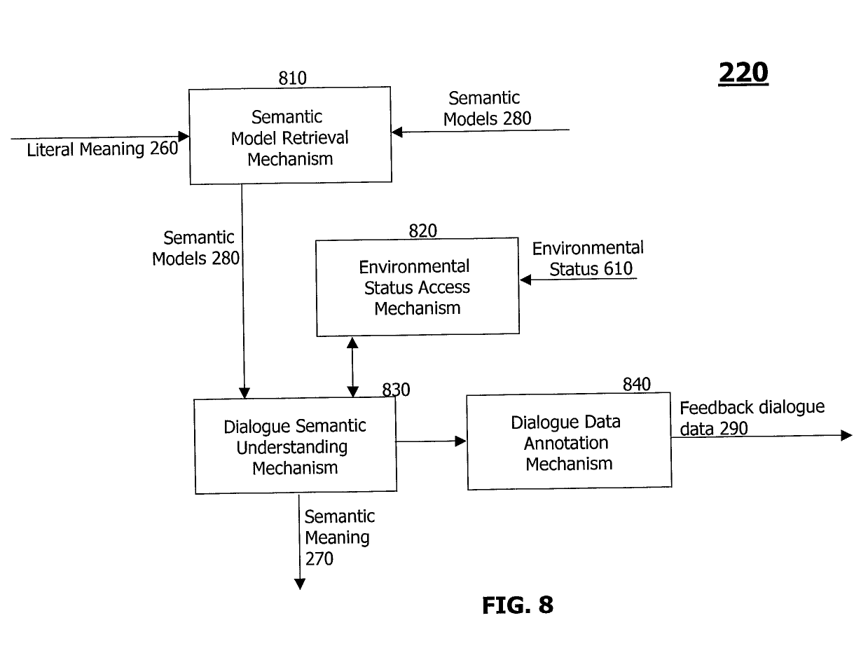

FIG. 8 depicts the high-level functional block diagram of the statistical dialogue manager 220 according to the present invention. In FIG. 8, the statistical dialogue manager 220 includes a semantic model retrieval mechanism 810, an environmental status access mechanism 820, a dialogue semantic understanding mechanism 830, and a dialogue data annotation mechanism 840. The semantic model retrieval mechanism 810 takes the literal meaning 260 as input and retrieves the semantic models that are relevant to the literal meaning 260. The retrieved semantic models are sent to the dialogue semantic understanding mechanism 830.

As shown in FIG. 8, the dialogue semantic understanding mechanism 830 may analyze the received semantic models (retrieved by the semantic model retrieval mechanism 810) and may determine the environmental information needed to interpret the semantic meaning corresponding to the literal meaning 260. Using the example shown in FIG. 3, the literal meaning 310 (“lower the volume”) have three possible semantic meanings (“lower the TV's volume” 330, “lower the stereo's volume” 340, and “lower the radio's volume” 350). To select one of the semantic meanings, the dialogue semantic understanding mechanism 830 also needs to learn relevant environmental information such as which device is currently on or off.

The dialogue semantic understanding mechanism 830 may activate the environmental status access mechanism 820 to obtain relevant environmental information. For example, it may request on/off information about certain devices (e.g., TV, stereo, and radio). According to the request, the environmental status access mechanism 820 may obtain the requested environmental information from the action server 250 (FIG. 2) and send the information back to the dialogue semantic understanding mechanism 830.

Analyzing the semantic models 280 and the relevant environmental status information 610, the dialogue semantic understanding mechanism 830 interprets the semantic meaning of the literal meaning 260. It may derive a most likely semantic meaning based on the probability information in the semantic models. Such determined semantic meaning, however, may need to be consistent with the environmental status information. For example, in FIG. 3, the much higher probability (0.8) associated with the choice of “lower the TV's volume” may indicate that the choice is, statistically, a most likely choice given the literal meaning “lower the volume”. But such a choice may be discarded if the current environmental status information indicates that the TV is not turned on.

It is possible that semantic meanings corresponding to a particular literal meaning may all have similar probabilities. For example, the three semantic meanings related to literal meaning “lower the volume” (in FIG. 3) may have probabilities 0.4, 0.35, and 0.25. In such situations, the dialogue semantic understanding mechanism 830 may determine the semantic meaning using different strategies. For example, it may accept multiple semantic meanings and pass them all on to the responding mechanism 240 to confirm with the user. When the responding mechanism 240 receives multiple semantic meanings, it may generate confirmation questions, prompting the user to confirm one of the multiple semantic meanings. A confirmation process may also be applied when there is only one semantic meaning to be verified.

In a different embodiment, multiple semantic meanings may also be filtered using other statistics. For example, different semantic meanings may distribute differently in terms of time and such distribution information may be used to determine the semantic meaning at a particular time. Using the example shown in FIG. 3, the TV may often be turned on in the evenings, the stereo system may often be played during day time on weekends, and the radio may be almost always turned on weekday mornings between 6:00 am and 8:00 am. When such information is captured in the semantic model for literal meaning 310, the dialogue semantic understanding mechanism 830 may request the environmental status access mechanism 820 to retrieve the current time in order to make a selection.

In FIG. 8, the dialogue data annotation mechanism 840 annotates the confirmed relationship between a literal meaning and a particular semantic meaning to generate on-line annotated dialogue data. Such data is sent to the dialogue semantic learning mechanism 230 as the feedback dialogue data 290 and may be used to derive new semantic models or adapt existing semantic models.

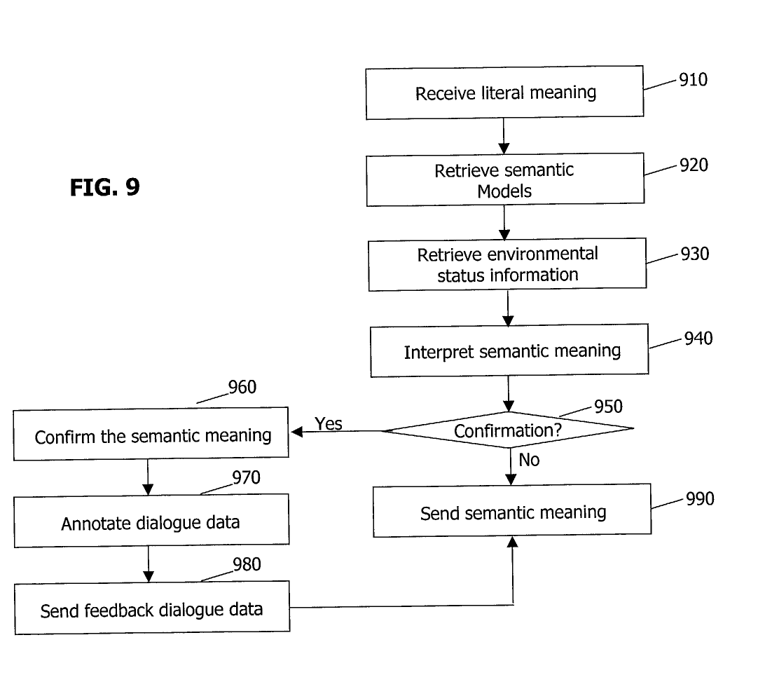

FIG. 9 is an exemplary flowchart of a process, in which the statistical dialogue manager 220 interprets the semantic meaning of input speech data based on semantic models corresponding to the literal meaning of the input speech data and associated environmental status, according to the present invention. The literal meaning 260 is received first, at act 910, from the speech understanding mechanism 210. According to the literal meaning 260, relevant semantic models are retrieved at act 920. Based on the semantic models, the dialogue semantic understanding mechanism 830 activates the environmental status access mechanism 820 to retrieve, at act 930, related environmental status information.

Using both the semantic models and relevant environmental status information, the dialogue semantic understanding mechanism 830 interprets, at act 940, the semantic meaning of the input speech. If a confirmation process is applied, determined at act 950, the statistical spoken dialogue system 130 confirm, at act 960, the interpreted semantic meaning with the user. The confirmation process may take several iterations. That is, the confirmation process may include one or more iterations of responding to the user, taking input from the user, and understanding the answer from the user.

Once a semantic meaning is confirmed, the dialogue data annotation mechanism 840 may annotate, at act 970, the confirmed dialogue to form feedback dialogue data and send, at act 980, the annotated feedback dialogue data to the dialogue semantic learning mechanism 230. The interpreted semantic meaning, which may or may not be confirmed, is then sent, at act 990, from the dialogue semantic understanding mechanism 830 to the responding mechanism 240.

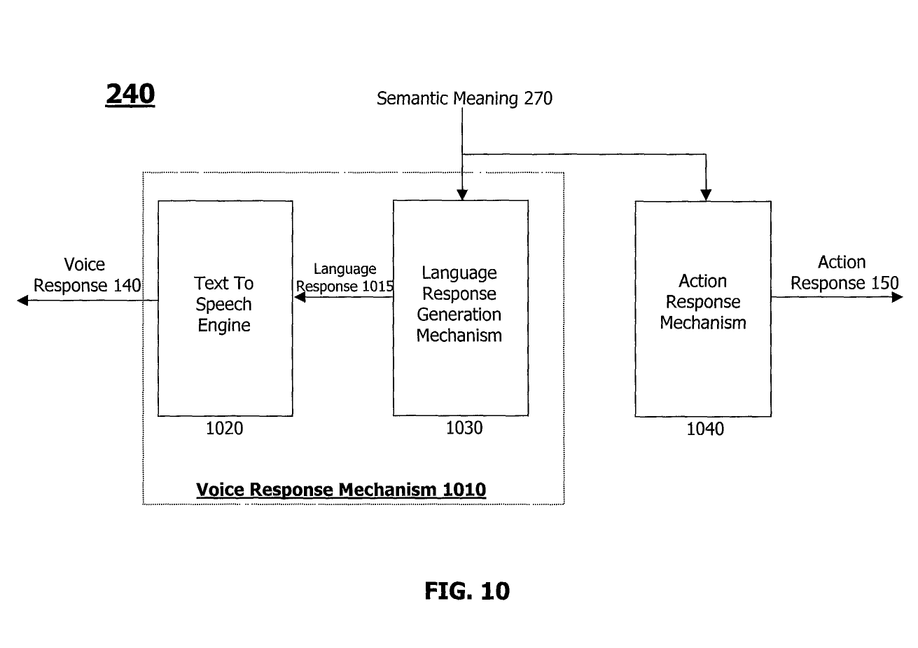

FIG. 10 depicts an exemplary internal structure of the responding mechanism 240, which comprises a voice response mechanism 1010 and an action response mechanism 1040. The responding mechanism 240 may be triggered when the statistical dialogue manager 220 sends the semantic meaning 270. Depending on the semantic meaning 270, the responding mechanism 240 may act differently. It may generate both the voice response 140 and the action response 150. It may also generate one kind of response without the other. For example, the responding mechanism 240 may generate an action response to perform certain function on a device (e.g., lower the volume of the TV in the family room) without explicitly letting the user know (via the voice response 140) that the requested action is being executed. On the other hand, a voice response may be generated to merely confirm with the user an interpreted semantic meaning. In this case, the corresponding action response may not be generated until the interpreted semantic meaning is confirmed.

In the exemplary embodiment illustrated in FIG. 10, the voice response mechanism 1010 comprises a language response generation mechanism 1030 and a Text-To-Speech (TTS) engine 1020. To generate the voice response 140, the language response generation mechanism 1030 first generates a language response 1015 based on the given semantic meaning 270. A language response is usually generated in text form according to some known response patterns that are either pre-determined or computed from the given semantic meaning 270.

The language response 1015 may be generated to serve different purposes. For example, it may be generated to acknowledge that the request from a user is understood and the requested action is performed. Using the example illustrated in FIG. 3, if the semantic meaning corresponding to “lower the TV's volume” is selected, language response “TV's volume will be lowered” may be generated. A language response may also be generated to confirm an interpreted semantic meaning. Using the same example in FIG. 3, a language response “do you mean to lower the volume of your TV?” may be generated to verify that semantic meaning 330 is the correct semantic interpretation.

In a text based dialogue environment, the language response 1015 (which is in text form) may be used directly to communicate with the user (e.g., by displaying the language response, in its text form, on a screen). In a spoken dialogue system, a language response is converted into voice, which is then played back to the user. In the embodiment described in FIG. 10, this is achieved via the TTS engine 1020. Through the TTS engine 1020, the language response 1015 is converted from its text form to waveform or acoustic signals that represent the voice response 140. When such waveform is played back, the voice response 140 is spoken to the user.

In FIG. 10, the action response mechanism 1040 generates, whenever appropriate, the action response 150. The action response 150 may be constructed as an activation signal that may activate an appropriate control mechanism, such as the action server 250 (in FIG. 2), to perform a requested action. To do so, the action response 150 may encode parameters that are necessary for the execution of the requested action. For example, the action response 150 may encode the designated device name (e.g., “stereo”), the controlling aspect of the device (e.g., “volume”), the action to be performed (e.g., “lower”) with respect to the aspect of the device, and the amount of control.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not limited to the particulars disclosed, but rather extends to all equivalent structures, acts, and, materials, such as are within the scope of the appended claims.

What is claimed is:

1. A statistical dialog system, comprising:
a speech understanding mechanism for determining the literal meaning of input speech data;
a dialog semantics learning mechanism for establishing semantic models based on annotated dialog training data, said annotated dialog training data associating literal meaning of input speech data with one or more semantic meanings of the input speech data; and
a statistical dialog manager for interpreting one semantic meaning of the input speech data based on both the literal meaning of the input speech data and corresponding semantic models that are associated with the literal meaning of the input speech data.

2. The system according to claim 2, wherein the speech understanding mechanism comprises:
a speech recognition mechanism for recognizing a word sequence from the input speech data based on at least one acoustic models; and
a language understanding mechanism for understanding the literal meaning of the word sequence based on a language model.

3. The system according to claim 1, further comprising a responding mechanism for generating at least one response to the input speech data based on the semantic meaning of the input speech data.

4. The system according to claim 3, wherein said responding mechanism includes:
a voice response mechanism for generating a voice response to the input speech data based on the semantic meaning of the input speech data; and
an action response mechanism for activating an action corresponding to the semantic meaning of the input speech data.

5. The system according to claim 4, wherein said voice response mechanism comprises:
a language response generation mechanism for generating a language response to the input speech according to the semantic meaning of the input speech data; and
a text to speech engine for synthesizing the voice of the language response to generate said voice response.

6. A dialog semantics learning mechanism, comprising:
an annotated dialog training data storage for storing annotated dialog training data that is either annotated off-line or fedback by a statistical dialog manager during on-line dialog sessions; and
a dialog semantic modeling mechanism for establishing semantic models of dialogs based on the annotated dialog training data.

7. The mechanism according to claim 6, further comprising a semantic model storage for storing the semantic models established by the dialog semantic modeling mechanism based on annotated dialog training data.

8. A system, comprising:
a semantic model retrieval mechanism for retrieving, from a semantic model storage, semantic models that are associated with a literal meaning of input speech data; and
a dialog semantic understanding mechanism for interpreting, during a dialog session, the semantic meaning of the input speech data according to said semantic models and said environmental status.

9. The system according to claim 8, further comprising:
an environmental status access mechanism for accessing environmental status that affects the interpretation of the semantic meaning of the input speech data, said environmental status being used, together with the semantic models, by the dialog semantic understanding mechanism to interpret the semantic meaning of the input speech data; and
a dialog data annotation mechanism for annotating the relationship between said literal meaning of the input speech data and the semantic meaning of the input speech data based on the dialog session to generate feedback dialog data.

10. A method, comprising:
receiving, by a statistical dialog system, input speech data;
determining, by a speech understanding mechanism in the statistical dialog system, the literal meaning of the input speech data;
retrieving at least one semantic model associated with the literal meaning of the input speech data, said at least one semantic model associating the literal meaning with at least one semantic meaning of the input speech data;
interpreting, by a statistical dialogue manager in the statistical dialogue system, the semantic meaning of the input speech data based on the literal meaning of the input speech data and the at least one semantic model; and
generating a response to the input speech data based on the semantic meaning of the input speech data.

11. The method according to claim 10, wherein said determining the literal meaning comprises:
recognizing, by a speech recognition mechanism, a word sequence from the input speech data based on at least one acoustic model; and
generating, by a language understanding mechanism, a literal meaning of the input speech data from the word sequence based on a language model.

12. The method according to claim 10, wherein said generating a response includes at least one of:
generating, by a voice response mechanism, a voice response to the input speech data based on the semantic meaning of the input speech data; and
generating, by an action response mechanism, an action response to the input speech data according to the semantic meaning of the input speech data.

13. The method according to claim 12, wherein said generating a voice response comprises:
producing, by a language response generation mechanism, a language response according to the semantic meaning of the input speech data; and
synthesizing, by a text to speech engine, the voice of said language response to generate said voice response.

14. A method for dialog semantic learning, comprising:
receiving annotated dialog training data that associates a literal meaning of input speech data with at least one semantic meaning of the input speech data; and
training a semantic model corresponding to the literal meaning of the input speech data based on the annotated dialog training data.

15. The method according to claim 14, further comprising:
storing the semantic model in a semantic model storage.

16. A method for a statistical dialog manager, comprising:
receiving, from a speech understanding mechanism, a literal meaning corresponding to input speech data;
retrieving, from a semantic model storage, at least one semantic model associated with the literal meaning of the input speech data; and
interpreting, by a dialog semantic understanding mechanism, the semantic meaning of the input speech data based on the literal meaning of the input speech data and the at least one semantic model.

17. The method according to claim 16, wherein said interpreting the semantic meaning comprises:
determining at least one semantic meaning of the input speech data according to the literal meaning and the at least one semantic model; and
confirming, based on the at least one semantic meaning of the input speech data, the semantic meaning associated with the literal meaning in a dialog session.

18. The method according to claim 17, further comprising:
accessing environmental status that affects the interpretation of the semantic meaning of the input speech data, said environmental status being used, together with the at least one semantic model, by said interpreting to generate the semantic meaning of the input speech data; and
annotating, by a dialog data annotation mechanism, the relationship between said literal meaning of the input speech data and the semantic meaning of the input speech data, confirmed during the dialog session, to generate feedback dialog data.

19. A computer-readable medium encoded with a program, said program comprising:
receiving, by a statistical dialog system, input speech data;
determining, by a speech understanding mechanism in the statistical dialog system, the literal meaning of the input speech data;
retrieving at least one semantic model associated with the literal meaning of the input speech data, said at least one semantic model associating the literal meaning with at least one semantic meaning of the input speech data;
interpreting, by a statistical dialogue manager in the statistical dialogue system, the semantic meaning of the input speech data based on the literal meaning of the input speech data and the at least one semantic model; and
generating a response to the input speech data based on the semantic meaning of the input speech data.

20. The medium according to claim 19, wherein said determining the literal meaning comprises:
recognizing, by a speech recognition mechanism, a word sequence from the input speech data based on at least one acoustic model; and
generating, by a language understanding mechanism, a literal meaning of the input speech data from the word sequence based on a language model.

21. The medium according to claim 19, wherein said generating a response includes at least one of:
generating, by a voice response mechanism, a voice response to the input speech data based on the semantic meaning of the input speech data; and
generating, by an action response mechanism, an action response to the input speech data according to the semantic meaning of the input speech data.

22. The medium according to claim 21, wherein said generating a voice response comprises:
producing, by a language response generation mechanism, a language response according to the semantic meaning of the input speech data; and
synthesizing, by a text to speech engine, the voice of said language response to generate said voice response.

23. A computer-readable medium encoded with a program for dialog semantic learning, said program comprising:
receiving annotated dialog training data that associates a literal meaning of input speech data with at least one semantic meaning of the input speech data; and
training a semantic model corresponding to the literal meaning of the input speech data based on the annotated dialog training data.

24. The medium according to claim 23, said program further comprising:
storing the semantic model in a semantic model storage.

25. A computer-readable medium encoded with a program for a statistical dialog manager, said program comprising:
receiving, from a speech understanding mechanism, a literal meaning corresponding to input speech data;
retrieving, from a semantic model storage, at least one semantic model associated with the literal meaning of the input speech data; and
interpreting, by a dialog semantic understanding mechanism, the semantic meaning of the input speech data based on the literal meaning of the input speech data and the at least one semantic model.

26. The medium according to claim 25, wherein said interpreting the semantic meaning comprises:
determining at least one semantic meaning of the input speech data according to the literal meaning and the at least one semantic model; and
confirming, based on the at least one semantic meaning of the input speech data, the semantic meaning associated with the literal meaning in a dialog session.

27. The medium according to claim 26, said program further comprising:
accessing environmental status that affects the interpretation of the semantic meaning of the input speech data, said environmental status being used, together with the at least one semantic model, by said interpreting to generate the semantic meaning of the input speech data; and
annotating, by a dialog data annotation mechanism, the relationship between said literal meaning of the input speech data and the semantic meaning of the input speech data, confirmed during the dialog session, to generate feedback dialog data.
